(19) United States
(12) Patent Application Publication
(10) Pub. No.: US 2007/0112623 A1
(43) Pub. Date: May 17, 2007

(54) E-mail rebate processing system

(76) Inventor: Michael Delasse, Sand Springs, OK (US)

Correspondence Address: William S. Dorman, 830 Beacon Building, 406 South Boulder, Tulsa, OK, 74103, US

(21) Appl. No.: 11/273,509

(22) Filed: Nov. 14, 2005

(51) Int. Cl. G06Q 30/00; G06Q 40/00

(52) U.S. Cl. 705/14; 705/39

(57) ABSTRACT

A system of doing business which includes accessing, by consumers, merchants and credit card partners a website maintained by the owner of the system, the website having a specialized account therein for each of the consumers, merchants and credit card partners, each account being particularly identified to that particular consumer, merchant or credit card partner, each consumer having a specialized rebate credit card individualized for that consumer so that the consumer can make a purchase from a manufacturer who is a subscriber to the system, the purchase being made through the rebate card for which the manufacturer may provide a rebate coupon, the consumer mailing the rebate coupon by conventional mail to the manufacturer along with the account information from the website peculiar to that consumer, the manufacturer, thereafter, sending a rebate by e-mail to that website to be credited to the consumer's account.

### BACKGROUND OF THE INVENTION

1. Field of the Invention

This invention relates to a method of doing business which includes the issuing of rebates to consumers; the rebate being issued electronically; i.e., by e-mail. Another feature of the present invention is that the consumer can use the exact same system to buy, sell or pay bills.

2. Prior Art

A preliminary search was conducted on the present invention and the following listed patents were uncovered in the search:

| Patent No. | Inventor | Issue Date |
|---|---|---|
| Re. 36,116 | McCarthy | Feb. 23, 1999 |
| 4,750,119 | Cohen et al. | Jun. 7, 1988 |
| 5,056,019 | Schultz et al. | Oct. 8, 1991 |
| 5,200,889 | Mori | Apr. 6, 1993 |
| 5,729,693 | Holda-Fleck | Mar. 17, 1998 |
| 6,039,244 | Finsterwald | Mar. 21, 2000 |
| 6,748,365 | Quinlan et al. | Jun. 8, 2004 |
| 6,847,935 | Solomon et al. | Jan. 25, 2005 |
| 6,865,544 | Austin | Mar. 8, 2005 |

| Publication No. | Inventor | Publication Date |
|---|---|---|
| 2002/0152118 A1 | Hadjigeorgis | Oct. 17, 2002 |
| 2002/0161641 A1 | Quinlan et al. | Oct. 31, 2002 |
| 2003/0229540 A1 | Algiene | Dec. 11, 2003 |
| 2004/0215514 A1 | Quinlan et al. | Oct. 28, 2004 |
| 2005/0149387 A1 | O'Shea et al. | Jul. 7, 2005 |

McCarthy Reissue Patent No. 36,116 relates to a centralized system of accumulating cash value for consumers utilizing devices and techniques which are not common to the present invention.

Cohen et al., U.S. Pat. No. 4,750,119 describes a system having a rebate feature, but the devices and techniques in Cohen et al., are different from the present invention.

Schultz et al., U.S. Pat. No. 5,056,019 involves an automated purchase reward accounting system and method which includes automatic tracking of consumer purchases and providing fulfillment and redemption of purchase incentives.

Mori U.S. Pat. No. 5,200,889 discloses a system for maintaining continuous total of refund amounts due a customer and for allowing customer designation of the amount of refund to be applied to the purchase.

Holda-Fleck U.S. Pat. No. 5,729,693 discloses a system for automatically providing an electronic consumer rebate.

Finsterwald U.S. Pat. No. 6,039,244 discloses a method of building up a data bank containing customer data and for the organization of a rebate or coupon system.

Quinlan et al., U.S. Pat. No. 6,748,365 discloses a method for redeeming product marketing rebate.

Solomon et al., U.S. Pat. No. 6,847,935 discloses a system for computer-aided rebate processing.

Austin U.S. Pat. No. 6,865,544 discloses a method of administering a rebate system wherein the cash value of a rebate is placed in an omnibus trust account.

Patent Publication 2002/0152118 A1 discloses a system which involves a computer-network, point of sale reward program.

Patent Publication 2002/0161641 A1 discloses a method for redeeming product marketing rebates.

Patent Publication 2003/0229540 A1 discloses a rebate issuance and reconciliation system.

Patent Publication 2004/0215514 A1 discloses a method for redeeming product marketing rebates.

Patent Publication 2005/0149387 A1 discloses an apparatus and method for redeeming and processing product marketing rebates using a radio frequency identification system proof-of-purchase technology.

A review of the above patents and publications will show that none of them show the feature of utilizing e-mail to credit rebates or to buy, sell or pay bills.

### SUMMARY OF THE INVENTION

The present invention involves a system or method for doing business at a website on the internet wherein the website is owned, operated and maintained by the owner of the system. The website provides accounts for participants in the system. These participants will be merchants, consumers, credit card providers, etc. For the sake of simplicity, the system will be identified as United Electronic Rebate Processing System (“UERPS”). The persons and entities who do business through the UERPS website are preferably subscribers and/or members of the UERPS system. The provider of the UERPS system will maintain a bank through the website. The website will also include an account for each of the participants in the website and each account will include a number or other identifying means which is peculiar to that particular participant.

Each consumer will be provided with his individualized UERPS credit (rebate) card. Initially, the UERPS credit card is applied for through the website at which time an inquiry is made through the FED as to whether or not the consumer has sufficient funds in his bank account to take care of the processing fee for the UERPS credit card. Assuming that the inquiry through the FED is in the affirmative, the credit card is issued to the consumer and the consumer's individualized account at the website is debited an amount equivalent to the processing fee. Thereafter, the consumer can utilize his UERPS credit card to purchase goods from merchants who are preferably members of the UERPS system.

If the consumer goes to a merchant who displays or handles the goods of a manufacturer who is a member of the UERPS system, the consumer will utilize his UERPS credit card in making the purchase, after which the consumer is or may be given a rebate coupon from the manufacturer. At this time, the consumer mails the rebate coupon along with his individualized UERPS credit card information to the manufacturer. As soon as the manufacturer receives the rebate information, the manufacturer will send, by e-mail, the rebate in question to the website and the amount is automatically credited to the account of the consumer.

If the consumer makes a purchase which turns out to be unsatisfactory, after delivery, he can file a request for stop payment at the UERPS website. If the manufacturer has not been paid by the UERPS website, the persons who handle the UERPS website will investigate the claim and make a determination as to whether or not the claim of the consumer is valid. Should the claim of the consumer be upheld, the money which would have gone to the manufacturer from UERPS is withheld and this amount is credited to the consumer minus the handling fee involved in processing the stop payment claim.

### BRIEF DESCRIPTION OF THE DRAWINGS

FIG. 1A is a block diagram indicating the various steps, from the inception of the program, to the use of credit cards, rebate cards, banks etc.,

FIG. 1B is a continuation from FIG. 1A and includes details of the e-mail account, ending up with the ultimate deposit of the rebate in the cardholders account.

FIG. 2 is a block diagram showing the steps involved in using the system of the present invention for the purchase and payment of goods and for stop payment.

FIG. 3 is a block diagram showing the relationship of the participants in program with consumers, merchants, credit card partners and the hardware involved in the system.

### DETAILED DESCRIPTION OF THE PREFERRED EMBODIMENTS

As will appear hereinafter the present invention involves a method of doing business wherein retailers, venders and manufacturers can send cash rebates to anyone with an e-mail address and a special rebate (credit) card designed for use with this particular system. Consumers can use cash to pay bills to any company or individual if cash is credited to the consumer at the website.

For the purpose of explanation, the system described herein will be referred to as United Electronic Rebate Processing System (“UERPS”).

Thus, the UERPS rebate card will be essentially the same as a conventional credit card and will contain the necessary indicia thereon identifying the particular cardholder (consumer). Before discussing the drawing figures in detail, it should be pointed out that this method of doing business includes the idea of issuing rebates to consumers. The consumer and the manufacturer (the one who issues the rebate) both must belong to UERPS. The merchant may not necessarily belong to UERPS. After the consumer makes a purchase at the merchant's place of business and receives his rebate from the manufacturer, he mails the rebate information along with his UERPS identification to the manufacturer and thereafter the manufacturer transmits the rebate electronically (and by e-mail) to the consumers account with UERPS.

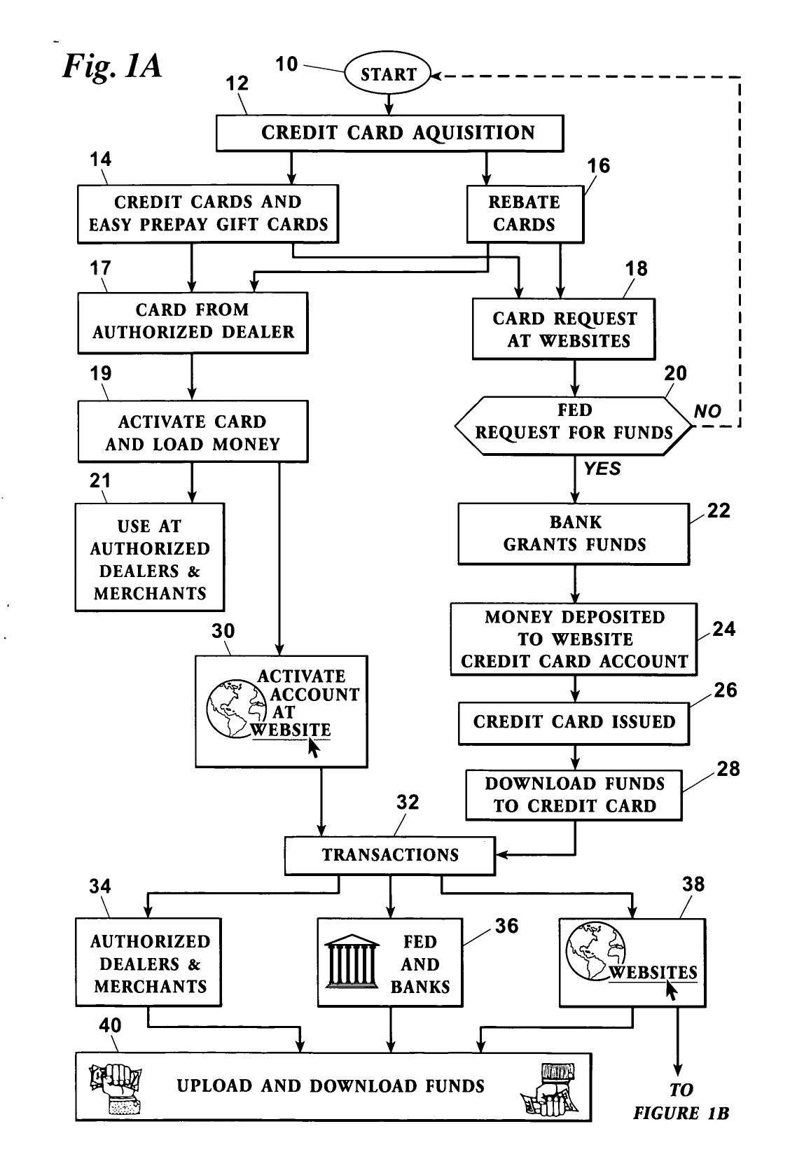

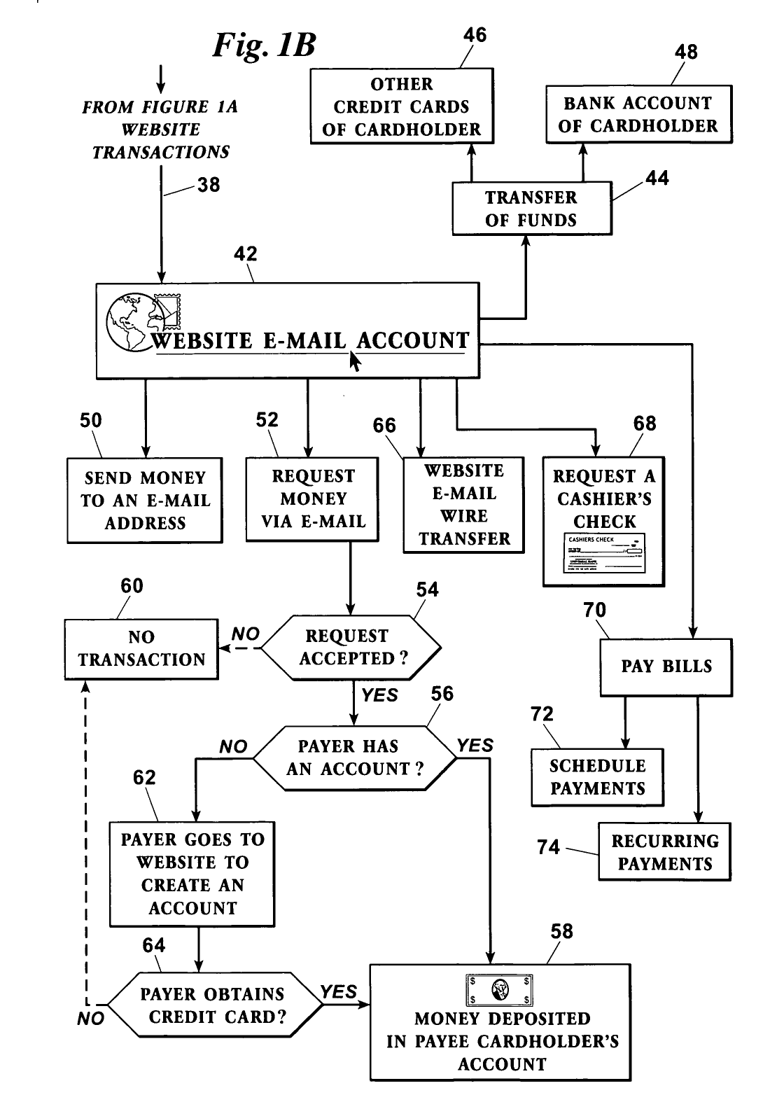

Referring now, in particular, to FIG. 1A, it will be assumed that a consumer will approach starting point 10 for the purpose of obtaining a credit card 12 which can be an ordinary credit card 14 or a rebate card 16. In the event that an ordinary credit card 14 is desired, the consumer can obtain that from the dealer 17 at which time the card is activated 18 for the purpose of use at authorized dealers and merchants 20 for the purchase of goods.

The rebate card 16, on the other hand, is designed particularly for the purposes of this present invention and contains indicia thereon which the program provider inscribes on the card to identify the particular consumer. The rebate card, however, will not be free but will require a processing fee, ultimately, from the consumer. The consumer then takes his rebate card 16 and makes a request through his website 18 to have the card actuated. The card request 18 is transmitted to the FED 20 for the purpose of requesting the funds necessary to purchase the card. Assuming that the account which the consumer has at the FED is sufficient for the purposes of the payment for the rebate card, authorization (“yes”) is obtained from the bank 22 and the funds are provided for the processing of the rebate card 16.

The consumer makes a request to the consumers bank. If the bank indicates that the consumer has sufficient funds for the processing fee (“yes”) the Bank grants funds 22. If the bank indicates that the consumer has no funds (“no”) the rebate and will not be advanced and processing will start over.

If the FED 20 determines that there are sufficient funds in the consumers bank, a wire transfer is made from the consumer's bank to the UERPS bank and money is deposited to the website as a credit to the consumer's account for the rebate card 24, at which time the credit card is issued 26 based upon the initial request for the rebate card 16. At this point, the credit card 26 is available to download 28 (or upload) funds to the card 26 in a manner later to be described.

In the meantime, the credit card 14 which was authorized by dealers and merchants 20 is available for use at the website provided, however, the card is activated 30 by going through a procedure which is essentially the same as that described in items 20 through 28 for the rebate card 16. In this fashion, a processing fee for the credit card 14 goes from the consumers bank to the UERPS bank.

The credit card 14 which is actuated at 30 and the rebate card 16 which has funds downloaded to it at 28 can now be used for a plurality of different transactions such as, dealing with authorized dealers and merchants 34, dealing with the FED and banks 36 or dealing with various websites 38. If it is desired to engage in a transaction 32 to authorized dealers and merchants 34, the FED and banks 36 and/or the websites 38, this would involve the uploading and downloading of funds 40. In the case of authorized dealers and merchants, the uploading and downloading would involve primarily cash transactions. In uploading and downloading funds from the FED and banks 36 this could involve accessing the consumer's checking and/or saving account; and, in the case of the website 38 the uploading and downloading of funds would take the path making request to the website account 42 as set forth in FIG. 1B.

Turning now to FIG. 1B, the website transaction involved, first of all, accessing the consumers website e-mail account 42 if it is desired to transfer funds 44 to and from the e-mail account 42. This can be accomplished by connecting to other credit cards 46 of the cardholder or to the bank account 48 of the cardholder electronically through the website itself.

The consumer who possesses the e-mail account 42 can send money to an e-mail address 50 or request money by e-mail 52. If the recipient of the e-mail 50 is a member of the UERPS system, the money will be readily credited to his account; if the recipient is not a member of the UERPS system, he will begin his registration with the UERPS system to get his money out.

If money is requested by way of e-mail 52, obviously, this requires action on the part of the recipient of the request. If the request is accepted 54 and the payer has an account 56 and there are sufficient funds (“yes”), then money is deposited 58 to the consumers account at the website. If the recipient of the request 52 declines the request (“no”) there is no transaction 60. If the request is accepted 54 and the payer has an account 56 but with insufficient funds (“no”) then the payer must approach the website to create UERPS account 62. If thereafter the payer obtains a credit card 64 then the money can be deposited to the payee cardholders account 58. Otherwise, (“no”) there will be no transaction.

In the event that the owner of the website e-mail account 42 wishes to send money to someone who is not a member of the UERPS system he will send money by wire transfer 66 which involves a wire transfer from the UERPS website to the bank of the recipient and the recipient will be also notified, simultaneously by e-mail that such a transfer has been made. In the event that the owner of the website e-mail account 42 wishes to have a cashier's check prepared, he requests of the UERPS bank for such a cashier's check 68 and the UERPS bank will simply issue this check.

Continuing with further consideration of FIG. 1B, in the event that the consumer accessing the website e-mail account 42 wishes to utilize his e-mail account to pay bills 70, for example, to Ajax Communications®, he notifies the manager of the UERPS account at the website that he wishes to have the bill paid and provides the manager with the necessary information as to address, Ajax® bank account, the amount involved, and the UERPS system will take care of making the payment and, of course, charge the account holder a fee for the service. As an added feature, in the event that the owner of the account 42 wishes to schedule payments 72 with Ajax® he will notify the provider of the UERPS account and they will take care of it automatically and charge accordingly. The same considerations hold true for recovering payments 74, in the event that the holder of the webside e-mail account wishes to have the UERPS provider take care of recovering payment for him.

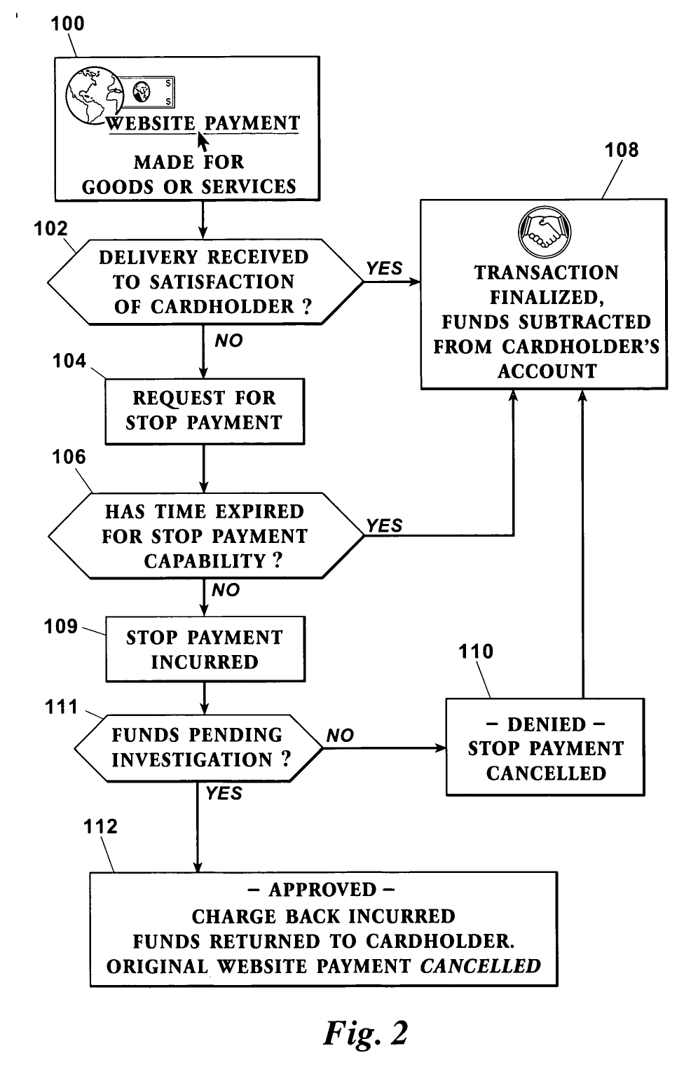

FIG. 2 represents the procedures involved in stopping payment of a purchase under the system of the present invention. Assuming, for example, that the holder of an account purchases a computer from Golden Bear Computer Company in Long Beach and has made payment 100 to Golden Bear through the website, (the consumer and Golden Bear are obviously members of the UERPS). Some time later, delivery 102 was made of the computer and the purchaser was not satisfied with the qualify of the merchandise (“no”) and filed a request 104 by e-mail with the UERPS provider at the website. After the request 104 has been filed with the provider, the provider has to make a determination as to whether or not the stop payment will be honored. Certain factual determinations will have to be made; for example, has the time expired 106 for the stop payment. If the provider decides that the time has expired (“yes”) then the transaction is finalized 108. If the time has not expired, stop payment occurs 109 and the provider of the UERPS system sets aside an amount in controversy into a special account 111 pending investigation. If the results of the investigation are favorable to the manufacturer (“no”), then the stop payment will be denied 110 and the transaction will be considered finalized with funds being transferred 108 from the cardholder's account to the manufacturer. If the results of the investigation are favorable to the cardholder, the funds are returned 112 to the consumer minus whatever stop payment fees will incur.

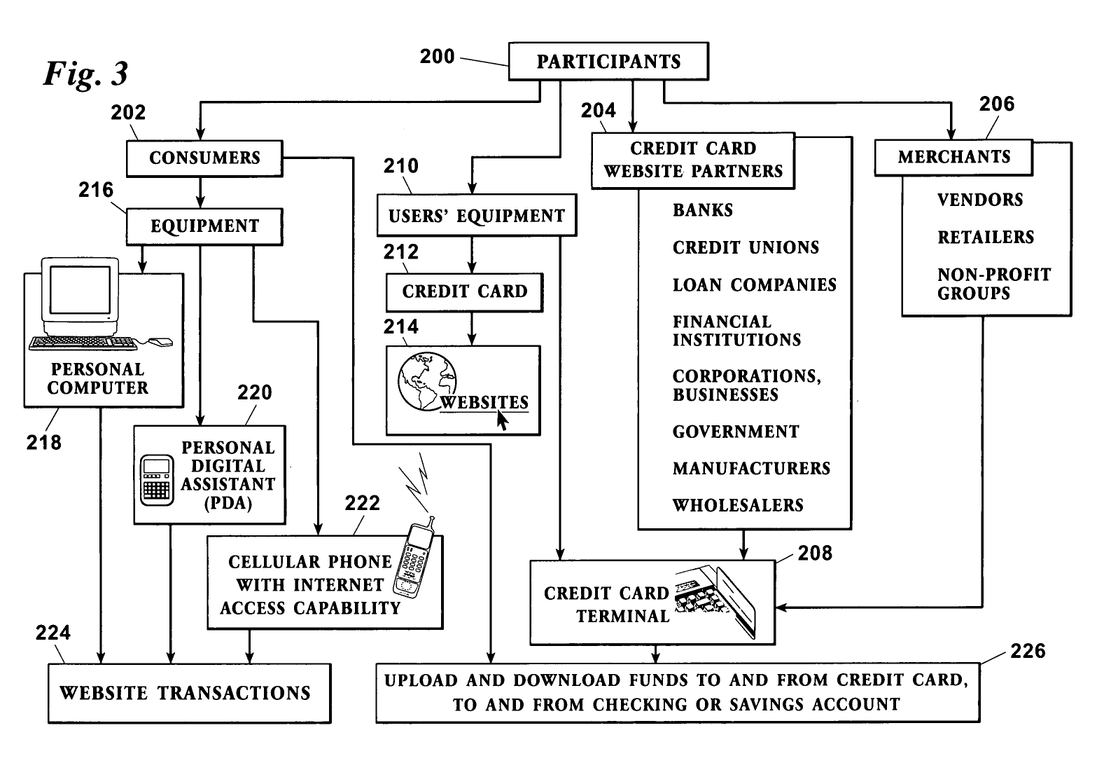

FIG. 3 is a block diagram representing the participants 200 who are involved in this UERPS system. The participants are people and things which are involved in this e-mail system of doing business and includes consumers 202, credit card website partners 204 and merchants 206. The credit card website partners 204 also include banks, credit unions, loan companies, financial institutions, corporations, businesses, government, manufacturers and wholesalers; all of the foregoing would have available a credit card terminal 208 to employ in the furtherance of the system. The merchants 206 include vendors, retailers and non-profit groups all of whom also have available a credit card terminal 208. The participants 200 are also provided user's equipment 210, credit cards 212, which permit access to the website 214. The user's equipment also can access through the credit card 212 with the credit card terminal 208.

The consumers 202 also have the equipment 216 which include personal computers 218, personal digital assistants 220, cellular phones having internet access 222 and other devices which would permit the consumers to access the website for the various website transactions 224. The consumers 202 would not normally have access to the credit card terminal 208 because the same is not necessary; but they can upload and download funds 226 utilizing the various components described.

Whereas the present invention has been described in particular relation to the drawings attached hereto, it should be understood that other and further modifications of this invention, apart from those shown or suggested herein, may be made within the spirit of this invention.

What is claimed is:

1. A system of doing business which includes accessing, by consumers, merchants and credit card partners a website maintained by the owner of the system, the website having a specialized account therein for each of the consumers, merchants and credit card partners, each account being particularly identified to that particular consumer, merchant or credit card partner, the improvement whereby each consumer will have a specialized rebate credit card individualized for that consumer so that the consumer can make a purchase from a manufacturer who is a subscriber to the system, the purchase being made through the rebate card for which the manufacturer may provide a rebate coupon, the consumer mailing the rebate coupon by conventional mail to the manufacturer with the account information from the website peculiar to that consumer, the manufacturer, thereafter, sending a rebate by e-mail to the website to be credited to the consumer's account.

2. A system of doing business as set forth in claim 1 wherein each consumer will request the issuance of the specialized rebate card from the owner of the system, the FED will be asked to check with the bank of the consumer to determine if sufficient funds are available for the processing fee for the card, and the card will be authorized for use if the approval of the FED is obtained.

3. A system of doing business as set forth in claim 1 wherein each of the consumers can send money to a third party e-mail address from his own e-mail account.

4. A system of doing business as set forth in claim 1 wherein each consumer can request money from a third party by way of e-mail from the website and if the request is honored, the person requested will have money deposited into the cardholders account.
